(19) United States
(12) Patent Application Publication
(10) Pub. No.: US 2009/0023111 A1
(43) Pub. Date: Jan. 22, 2009

(54) Method for vertical positioning of dental implants

(76) Inventor: Dana Alan Carlton, (US)

Correspondence Address: Mitchell, Silberberg & Knupp, 11377 West Olympic Boulevard, Los Angeles, CA, 90064, US

(21) Appl. No.: 11/984,645

(22) Filed: Nov. 20, 2007

Related U.S. Application Data
(62) Division of application No. 11/476,987, filed on Jun. 27, 2006, now abandoned.

(51) Int. Cl. A61C 8/00

(52) U.S. Cl. 433/215

(57) ABSTRACT

A positioning device is used to place an implant in the proper vertical position within the soft tissue and bone, provide space for subsequent procedures, and create a proper emergence profile for the final restoration. The lower portion of the positioning device has substantially the same outer shape as that of the implant but without external screw threads or other mechanical features for anchoring the implant in the jawbone. After the hole is countersunk, the depth of the hole in the jawbone is increased incrementally and checked with the positioning device for collar engagement and location of the margin within the gum tissue and bone. After the proper vertical position is attained, a special countersink bur may be used to create needed space around the implant margin and provide a proper crown emergence profile.

This application is a divisional of U.S. patent application Ser. No. 11/476,987, filed Jun. 27, 2006.

### BACKGROUND OF THE INVENTION

1. Field of the Invention

This invention is concerned with dentistry, and in particular with a method for vertical positioning of dental implants.

2. Description of the Related Art

Dental implants are used in the practice of dentistry to replace teeth that have become unserviceable and/or painful to the patient due to disease or physical damage. A tooth implant basically comprises a metallic implant part, a metallic abutment, and a crown. The implant part typically has a threaded cylindrical bottom portion that is screwed into a drilled and tapped hole in the jawbone, and a conically tapered top portion that preferably extends to below the outer surface of the gum tissue. For some implant parts, the cylindrical lower portion is tapered, being slightly smaller in diameter at the bottom. The abutment typically comprises a tapered post at the top and a threaded cylindrical bottom portion that screws into an axial blind threaded hole in the top of the implant part. For anchoring dentures or bridges, the abutment may be in the form of a ball (attached to a threaded shaft) or other geometric shape. The crown is usually a metal-porcelain composite prosthesis that is attached to the top of the abutment, typically by means of a dental adhesive. Preferably, the bottom edge of the crown extends below the gum surface so that the metallic implant is not visible. The implant part and abutment are usually composed of a titanium alloy, whereas a gold alloy is usually used to fabricate the crown.

FIG. 1 illustrates two typical dental implant types. FIG. 1(A) depicts an onolithic implant 101 comprising an implant upper portion 102 and an implant lower portion 103 separated by an implant margin 104, which is the outer edge of implant 101. Implant upper portion 102 comprises an implant shoulder 105, an implant top 106 and an axial threaded hole 107 (for attaching an abutment). Note that axial hole 107 may extend into implant lower portion 103 (as shown) but is considered part of implant upper portion 102 (where the axial threaded hole opening is located). Implant lower portion 103 comprises an implant collar section 108 (comprising an implant collar 109), an implant cylindrical section 110 (with implant external threads 111), and an implant bottom end 112. Implant collar 109 typically has a conical shape (as shown), whose vertical cross-section defines the implant emergence profile. The geometry of the implant bottom end varies depending on the manufacturer and may be square, spherical, elliptical or conical (as shown), and may include tapping threads (to render the implant self-tapping).

FIG. 1(B) depicts an implant similar to implant 101 but consisting of separate top and bottom pieces. Top piece 121 has a top section 123, which includes implant top portion 102 and implant collar section 108. Top piece 121 screws into an axial threaded hole in bottom piece 122, which includes implant lower portion 103. The terminology given in paragraphs [0003] and [0004] is used throughout this document and encompasses both monolithic implants and those consisting of multiple pieces.

FIG. 2 illustrates the basic steps involved in a typical tooth implant procedure. After the natural tooth (or a previous implant) has been extracted and new bone has grown in the socket, a hole 204 of a predetermined diameter (to fit the implant) is drilled through the gum layer 202 and the cortical layer 203 and into the cancellous bone 201 of the jawbone (FIG. 2A), typically using a plurality of drill bits of increasing diameter. Hole 204 may then be tapped to produce internal threads 205 (FIG. 2B) that match those on implant 210 (FIG. 2D). For some implant types, those with self-tapping threads, for example, tapping of hole 204 is not required. The entrance to hole 204 is typically countersunk to produce a countersunk area 206 (FIG. 2C) having sides of substantially the same cross-section profile as the collar of implant 210. The externally threaded portion of implant 210 is screwed into hole 204 using an insertion tool or an intermediate transfer abutment (not shown) that screws into threaded axial abutment hole 211 (threads not shown) at the top of implant 210 (FIG. 2D). Ideally, implant 210 bottoms out at the bottom of hole 204 and engages countersunk region 206 without a gap, and the margin of implant 201 is below the surface of gum 202 (as shown). After sufficient time (usually several weeks to months) is allowed for the gum tissue and bone to heal and for the implant to stabilize biologically, threaded shaft 212 of abutment 213 is screwed into hole 211 (FIG. 1E). Abutment 213 typically has a conical shape (as shown) but may have a variety of geometric shapes. During the implant stabilization time, a threaded “healing” cap (not shown) is screwed into hole 211 to prevent intrusion and accumulation of food debris and soft tissue in the hole. The implant procedure is completed by attaching crown 214 (using a dental adhesive) to abutment 213 (FIG. 1F). To obtain an impression for making the crown, an impression cap is snapped onto, or is otherwise installed on, the margin of the implant, which, to be accessible, must be within the soft tissue (gum) rather than flush with or below the surface of the cortical layer of the jawbone. Preferably, the emergence profile of crown 214 is a smooth extension of the emergence profile of the collar of implant 210, as depicted in FIG. 2(F).

A critical aspect of the dental implant procedure is proper vertical positioning of the implant with respect to depth in the hole in the jawbone. Preferably, the implant margin is positioned within the gum. In this case, the crown can be attached at the optimum functional height (relative to other teeth) without removing gum tissue and without leaving an aesthetically unpleasing gap between the gum and crown. The implant margin should also protrude sufficiently above the cortical bone to enable installation of an impression cap (without an additional surgical procedure), as well as formation of a smooth emergence profile for the crown relative to that of the implant collar.

It is also preferred that the implant bottom out in the hole so that the resistance to vertical movement provided by the implant threads is enhanced by the bone at the bottom of the implant. In addition, it is preferred that at least part of the conically tapered portion of the implant fit into a countersunk area in the jawbone hole. In this case, the larger contact area between the implant and the jawbone associated with the taper enhances both vertical and lateral stability for the implant. Additional stability is provided if the countersink includes more of the cortical layer, which is harder and stronger than the underlying cancellous bone. The extent to which countersinking is practical for available implant sizes depends on the thickness of the gum tissue, which varies significantly from person to person, and from site to site within the mouth. From these considerations, it is evident that precise vertical positioning of dental implants is important.

It is also important that the implant be positioned correctly on the first attempt since the implant is often difficult to remove without damage to the surrounding bone. This is partly because the coefficient of friction between the implant and the bone tends to be high, and partly because the implant threads are typically designed to bind to the bone so as to prevent movement of the implant during initial healing and in service (after the crown is attached). If the implant is too high relative to the gum and has to be removed to increase the depth of the hole, damage to the hole threads and bone during removal of the implant and/or during the subsequent drilling operation may significantly reduce the stability of the implant. This thread damage may be exacerbated by cross-threading during a second (or subsequent) attempt to install the implant, which is more likely for already damaged hole threads.

Prior art methods and devices for vertical positioning of dental implants do not provide optimum results. One method involves use of a mechanical drill stop to provide the required depth for the hole in the jawbone. This approach does not provide adequate precision due to the uneven nature of bone surfaces and the pliability of gum tissue.

Another prior art method for vertical positioning of dental implants involves use of a depth gauge comprising a smooth metallic rod having a diameter that is the same as the lower portion of the implant, not including the threads. The depth gauge is fully inserted in the hole and markings (usually in the form or rings) spaced at intervals along the cylinder length are used to gauge the depth of the hole in the jawbone. FIG. 3 illustrates a cylindrical depth gauge 304 (with ring markings 305) being inserted into a hole 306. In this case, choice of a reference point is a significant difficulty since the surface of gum 302 is typically uneven and poorly defined, and the surface of cortical layer 303 is typically uneven around the hole.

Both of these prior art methods have the major disadvantage of providing no means for adequately taking into account the effect of the implant collar conical taper (generally used in modern dental implant practice), or of the soft tissue (gum) thickness and its relationship to the emergence profile of the final crown. In particular, the depth of the lower edge of the countersunk area relative to the bottom of the hole is difficult to determine using a cylindrical gauge, especially since the top of the countersunk area tends to be irregular. In some cases, the implant, as it is screwed into the hole, may bottom out at the hole bottom before the implant taper engages the countersunk area, resulting in a gap that may compromise the esthetics, function and long-term survivability of the implant. Consequently, the implant must be removed so that the depth of the hole can be increased, which entails the problems discussed in paragraph [0008]. In other cases, the implant taper may bottom out against the countersunk area so that the implant is too high and must be removed so that the depth of the countersink can be increased, which also entails the problems discussed in paragraph [0008]. In some cases, especially when the gum tissue is thin, the implant may not bottom out until the implant margin is flush with or below the cortical layer outer surface so that an impression cap cannot be installed. In this case, a portion of the bone around the implant margin must be removed after the implant has been placed and integrated with the bone, which entails the expense, patient discomfort and infection risks of another surgical procedure.

For an implant installed such that the margin is near or below the jawbone surface, prior art procedures are also inadequate with respect to providing a crown emergence profile that is a smooth extension of the implant emergence profile. In this case, excess bone around the implant margin may be removed using a Strauman® bone profiler, for example. Such hole-saw type cutting tools cannot remove bone around the implant collar (underneath the margin) and are not suitable for providing the counter sink taper needed for a smooth transition between the emergence profiles of the implant collar and the crown. In some cases, the emergence profile of the crown may exhibit a step or discontinuity relative to the emergence profile of the implant collar, degrading the long-term stability and aesthetics of the implant.

From this discussion, it is clear that there is an important need for a means of ensuring, prior to installation, that a dental implant will be installed in the desired vertical position. Such a means would improve the quality and reduce the costs of dental implants by reducing the frequency with which dental implants must be removed for vertical repositioning. In addition, there is a need for a means of avoiding an additional surgical procedure due to the implant margin not being accessible for installation of an impression cap. Furthermore, there is a need for a means of providing a crown emergence profile that is a smooth extension of the emergence profile of the implant collar.

### SUMMARY OF THE INVENTION

The present invention provides an apparatus and a method for ensuring that a dental implant will be installed in a hole in the jawbone at a predetermined vertical position on the first attempt, and that a desired emergence profile of a crown installed on the implant will be attained. The desired emergence profile of the crown generally includes a smooth transition with respect to the emergence profile of the implant collar. A key element of the apparatus of the invention is an implant positioning device comprising a device upper portion and a device lower portion. The device lower portion has the same external geometric shape and dimensions as those of the implant lower portion but without external screw threads or other mechanical features for anchoring the implant in the jawbone.

In a preferred embodiment, the external geometric shape and dimensions of the positioning device are substantially identical to those of the implant minus any external screw threads or other mechanical features for anchoring the implant in the jawbone. For example, the top of the implant and the top of the positioning device may both include a threaded axial blind hole (typically used for attachment of an abutment) that mates to a screw on an implant insertion device, which may then be used as a handle to insert both the implant positioning device and the implant in the hole in the jawbone. Alternatively, the top of the positioning device of the invention may comprise a permanent handle, or may include a handle attachment other than that used for the implant.

The positioning device of the invention may also be used to gauge the quantity of bone removed by a countersink bur so as to ensure, prior to installation of an implant, that an impression cap will fit on the implant and a suitable crown emergence profile can be attained. In this case, the impression cap may be snapped on or otherwise installed on the positioning device while the positioning device is fully inserted in the hole in the jawbone. Lack of engagement of the impression cap on the fully inserted positioning device indicates inadequate relief of bone around the implant margin and the need for use of the extended countersink bur.

The positioning device of the invention may include an extended device collar section whose profile matches the desired crown emergence profile. Such an extended collar positioning device may be used to ensure that the desired crown emergence profile will be attained. The extended collar positioning device is preferably used in conjunction with an extended bur countersink tool, which is another optional element of the invention, that provides a countersunk area matching the desired emergence profile for both the implant and the crown.

The method of the invention for vertically positioning an implant comprising an implant lower portion having an implant collar with a conical taper and an implant cylindrical section with external screw threads comprises the following steps. A hole of the diameter needed to fit the implant is first drilled at the desired location in the jawbone to a depth slightly short of that expected to be required. The hole is then countersunk to provide a countersunk area tapered to match the conical taper of the implant collar. The implant positioning device of the invention is inserted into the hole until the lower end of the positioning device bottoms out at the bottom of the hole. The location of the positioning device margin (relative to the gum line) and the gap existing between the hole countersunk area and the positioning device collar are inspected and used to estimate the additional hole depth required. The implant positioning device is removed from the hole, which is then drilled deeper. The steps of inserting the implant positioning device, inspecting the location of the positioning device margin and the gap existing between the hole countersunk area and the positioning device collar, estimating the additional hole depth required, removing the implant positioning device, and drilling the hole deeper are repeated until the positioning device margin is properly located within the gum tissue and no substantial gap exists between the hole countersunk area and the positioning device collar.

After the steps of the invention have been performed, at least a portion of the hole is threaded using a thread tap (if required for the type of implant employed), and the implant is screwed into the hole until the conically tapered area of the implant is seated on the hole countersunk area. A healing cap is installed to prevent intrusion and accumulation of food debris and soft tissue in the hole during the implant stabilization time. After the implant has stabilized, an abutment is attached to the implant, typically by screwing a threaded screw at the bottom of the abutment into an axial hole in the top of the implant. The crown is then attached to the abutment on the implant.

The invention is useful for improving the accuracy of surgical implant placement, thereby improving the function and appearance of dental implants. By reducing the frequency with which implants must be removed for vertical repositioning, the invention is useful for ensuring the long-term survivability of the implant. In particular, the invention is useful for ensuring that the implant will not have to be removed due to lack of engagement between the conical taper on the implant collar and the hole countersunk area. In addition, the invention is useful for ensuring that the hole is drilled to the proper depth before being tapped (if required) so that possible damage to the threads and bone during drilling is avoided. Furthermore, the invention is useful for ensuring a smooth emergence profile for the crown relative to the implant, and for avoiding an additional surgical procedure for removing bone around the margin of an implant to enable installation of an impression cap.

The method of the invention may be incorporated in a computer aided implant placement system to improve the precision and efficiency of at least some of the steps of the method, including hole drilling and countersinking, placement device insertion, gap inspection, hole depth estimation, and/or bone machining. This involves creating a virtual system in the computer for planning and guiding the surgical procedure, splint or stent manufacturing, and clinical implant placement. This approach ensures that the bone and soft tissue are properly prepared so that the implant margin is precisely and correctly positioned. The computerized implant positioning system may be used in both clinical and non-clinical laboratory applications.

In the clinical computerized implant placement system of the invention, the implant positioning device and countersink burs are first duplicated in size and form using a two- and/or three-dimensional graphic-style computer program. These “virtual devices” are then used to plan and prepare clinical cases. The hard and soft tissue are virtually visualized based on a three-dimensional radiographic reconstruction of CT data, or data from another imaging method, ultrasound imaging, for example. Prior to the three-dimensional imaging, opaque (or equivalent) references are placed in or on the patient. The information obtained using the references and three-dimensional scans is then used to plan and perform computer-aided surgery.

Further features and advantages of the invention will be apparent to those skilled in the art from the following detailed description, taken together with the accompanying drawings.

### BRIEF DESCRIPTION OF THE DRAWINGS

FIG. 1 illustrates two typical implant types.

FIG. 2 illustrates the basic steps involved in a typical tooth implant procedure.

FIG. 3 illustrates use of a prior art device to gauge the depth of a hole drilled in a jawbone for installation of a dental implant.

FIG. 4 illustrates: (A) a typical dental implant part; and (B) a preferred corresponding implant positioning device according to the invention.

FIG. 5 illustrates various embodiments of the positioning device of the invention for vertical positioning a dental implant, as well as the extended countersink bur for use with a positioning device with an extended collar.

FIG. 6 illustrates a preferred embodiment of the method of the invention for vertical positioning of a dental implant when the gum tissue is relatively thick.

FIG. 7 illustrates use of the invention for vertical positioning of a dental implant when the gum tissue is relatively thin.

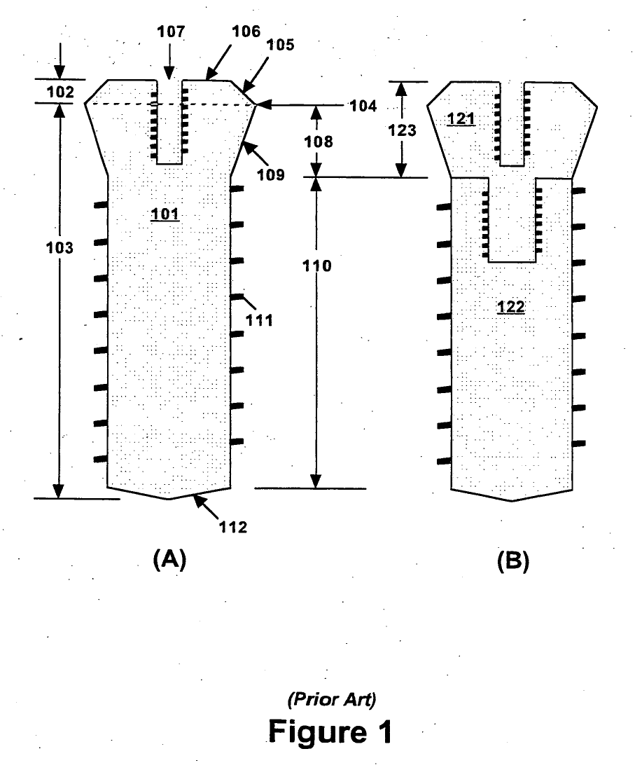

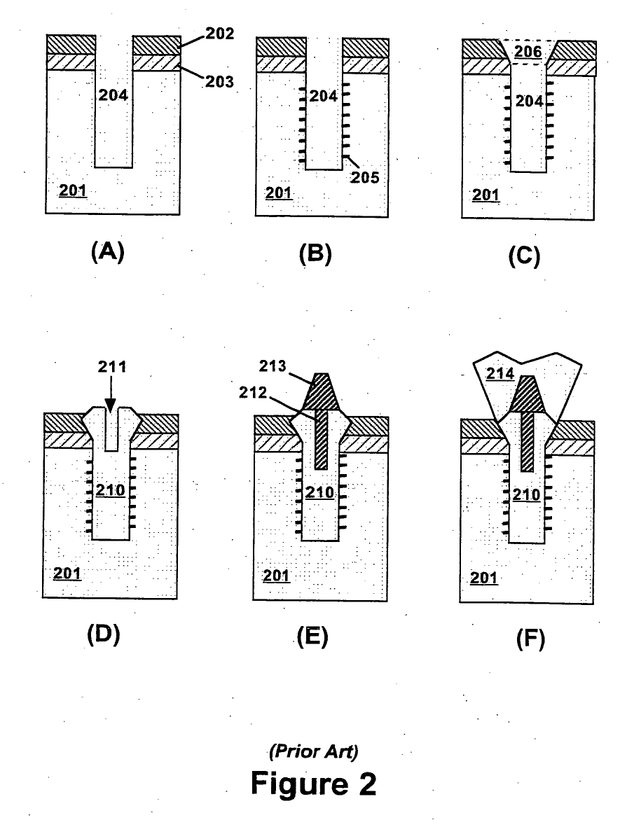

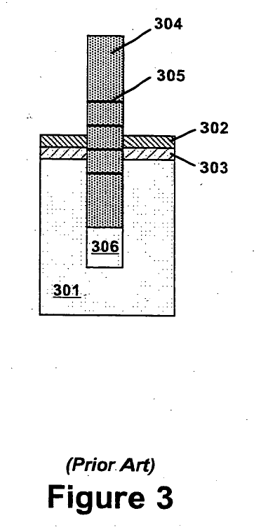

These figures are not to scale and some features have been enlarged for better depiction of the features and operation of the invention.

### DETAILED DESCRIPTION OF THE INVENTION

Technical terms used in this document are generally known to those skilled in the art. The term “vertical” denotes the direction along the axis of a hole in which a dental implant is inserted, wherein the “lower portion” of the implant (or implant positioning device) is located toward the bottom of the hole, and the “upper portion” of the implant (or implant positioning device) is located toward the top of the hole. The term “conical” is used in the general sense to denote a three-dimensional conical shape and encompasses both right circular cones and those for which an axial cross-section of the cone comprises a curved line. The term “conical” also encompasses implants with a conical emergence profile and a cylindrical top portion. As applied to the lower portion of an implant or implant positioning device, the term “cylindrical” also encompasses a lower portion tapered to have smaller diameter at the bottom.

The terminology used for an implant is the same whether the implant is monolithic or comprises a plurality of parts. As discussed in paragraphs [0003] and [0004], the “implant upper portion” generally comprises a “shoulder”, a “top” and an axial threaded hole (for attaching an abutment). The “lower portion” of an implant generally comprises a “collar section” comprising a “collar”, a “cylindrical section” (typically with external threads), and a “bottom end”. The upper portion and lower portion of an implant are separated by a “margin”, which is the outer edge of the implant. The term “profile” indicates the geometric shape of a cross section of a conically tapered object, an implant collar, for example. The geometry of the bottom tip of an implant varies depending on the manufacturer and may be square, spherical, elliptical or conical (as shown), and may include tapping threads (to render the implant self-tapping). The terminology used for the various areas and features of an implant also applies to a corresponding implant positioning device.

The term “external geometric shape” denotes the basic surface geometry of the lower portion of an implant, but does not include external screw threads or other mechanical features designed to anchor the implant in the jawbone. The term “external screw threads” includes both the external screw threads typically used to secure the implant to the jawbone, and any external threads used to provide self tapping. The “external geometric shape” of the positioning device also does not include holes (for hollow implants) or depressions in the implanted portion of the implant that are sometimes employed to help anchor the implant (via bone growth in the holes or depressions.

The present invention provides an apparatus and a method for ensuring that a dental implant will be installed in a hole in the jawbone at a predetermined vertical position on the first attempt, and that a desired emergence profile of a crown installed on the implant will be attained. The invention is particularly useful for vertically positioning a dental implant having an upper portion separated by a margin from a lower portion comprised of a conically tapered collar and a cylindrical section with external screw threads. A key element of the apparatus of the invention is an implant positioning device comprising a device upper portion and a device lower portion having the same external geometric shape and dimensions as the lower portion of the implant. The lower portion of the implant positioning device does not include external screw threads or other mechanical features, ridges or roughened surface texture, for example, designed to anchor the implant in the jawbone. The implant positioning device preferably comprises a dental titanium alloy but may comprise any suitable material. The surface of the lower portion of the implant positioning device is preferably sufficiently smooth to be easily inserted in and removed from the implant hole.

The apparatus of the invention for vertically positioning a dental implant having an implant upper portion, an implant margin and an implant lower portion comprises a positioning device having a device upper portion, a device margin, and a device lower portion. The device lower portion has substantially the same external geometric shape and dimensions as those of the implant lower portion but without external screw threads or other mechanical features for anchoring the implant in the jawbone.

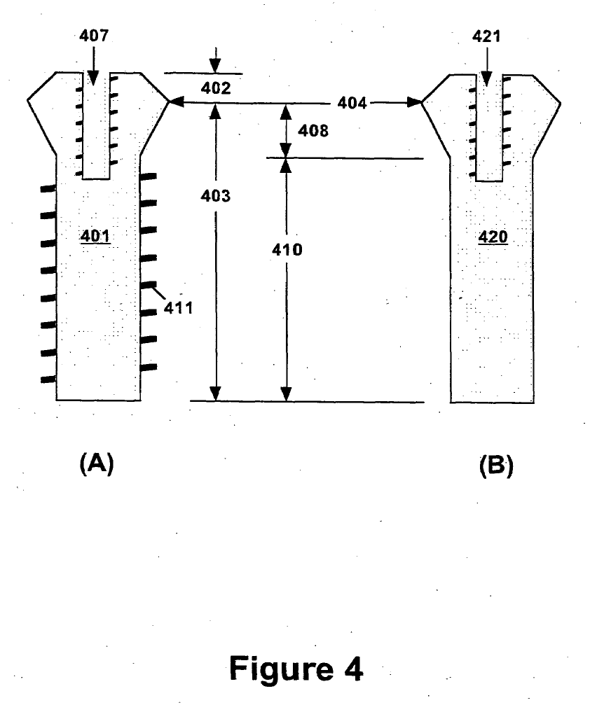

FIGS. 4(A) and 4(B), respectively, illustrate a typical dental implant 401 and a preferred corresponding implant positioning device 420 according to the invention. Both implant 401 and positioning device 420 comprise an upper portion 402 and a lower portion 403, which are separated by a margin 404. The lower portions of both implant 401 and positioning device 420 comprise a conically tapered collar section 408 and a cylindrical section 410, and have substantially the same external geometric shape and dimensions. Cylindrical section 410 of implant 401 includes external screw threads 411 which are not present on positioning device 420. Upper portion 402 of implant 401 includes a threaded axial hole 407, which is typically used to temporarily attach an implant insertion tool and a healing cap, and to permanently attach an abutment to which the crown is attached. Upper portion 402 of positioning device 420 includes a threaded axial hole 421, which is substantially identical to hole 407 and may be used to attach a handle to positioning device 420. Although the upper portions of implant 401 and positioning device 420 shown in FIG. 4 are identical, it is only necessary for the invention that the lower portions 403 of implant 401 and positioning device 420 have substantially the same external shape and dimensions, not including threads 411.

FIG. 5 illustrates various embodiments of the positioning device of the invention for vertically positioning a dental implant, as well as extended countersink burs for use with a positioning device with an extended collar. These drawings are not to scale but have the same relative vertical scale and are aligned with respect to the bottom ends. FIG. 5(A) depicts an implant 501 comprising an upper portion with a shoulder (above a margin) and an axial threaded hole 503 in the top (internal threads not shown), and a lower portion comprising a collar and a cylindrical section with external screw threads 502. FIG. 5(B) depicts an implant positioning device 510 that is substantially identical to implant 501 except for threads 502, which are not present on positioning device 510. FIG. 5(C) depicts an implant positioning device 520 with a lower portion 521 (below dotted line) that is substantially identical to the lower portion of implant 501, but with an upper portion 522 that includes a permanent handle. FIG. 5(D) depicts an implant positioning device 530 similar to the device in FIG. 5(C) but with a narrower handle designed to provide better visibility of the implant hole area.

FIG. 5(E) depicts a preferred implant positioning device 540 similar to device 530 but with a flat top surface (no shoulder) and a sharp margin designed to provide better visibility of the implant hole area. Note that the flat top of the positioning device of FIG. 5(E) is in a plane that includes the sharp margin, so that the location of the margin relative to the gum layer is readily apparent to an operator looking along the axis of the hole. This type of device may also have a removable handle that screws into a threaded axial hole in the top of the device.

FIG. 5(F) depicts a two-part implant positioning device 550 similar to device 540 but comprising a lower part 551 which comprises a cylindrical section, and an upper part 552 which comprises a collar section. Lower part 551 and upper part 552 are preferably attached together via an internal axial machine screw (not shown). This device configuration allows the emergence profile of the positioning device (determined by the collar profile of upper part 552) to be varied using the same lower part. Such a two-part positioning device is particularly useful for an implant comprised of two parts for which the implant emergence profile can be varied.

FIG. 5(G) depicts an implant positioning device with a lower portion 561 (below dotted line) that is substantially identical to the lower portion of implant 501 (below the implant margin), but with an upper portion 562 comprising an extended device collar that is tapered to match a desired emergence profile of the crown to be attached to the implant. This extended collar positioning device may be used to ensure that the countersunk area of the implant hole in the jawbone accommodates the desired crown emergence profile. In a preferred embodiment, extended collar positioning device 560 is used in conjunction with an extended countersink bur providing a countersunk area whose profile matches the emergence profile of the implant collar and the desired emergence profile of the crown.

FIG. 5(H) depicts an extended countersink bur 570 (with a rotation shaft 573) for use with extended collar positioning device 560. The cutting surface of extended countersink bur 570 has two sections (571 and 572) that provide a countersunk area having sections that match the emergence profiles of the implant collar and the crown to be attached. Appropriate mechanical features for countersink bur cutting surfaces are well-known in the art.

FIG. 5(I) depicts an extended countersink bur 580 that in addition to rotation shaft and cutting surface sections 581 and 582 has a bottom cylinder 583 that fits into the hole in the jawbone to guide the countersink bur and act as a travel stop during the countersinking operation. The length of bottom cylinder 583 relates to the length of the implant.

The geometries described here for the positioning device and extended countersink bur of the invention are intended to be illustrative rather than inclusive. Other suitable geometries will be readily apparent to those skilled in the art.

The implant positioning device of the invention may comprise any suitable material, including a metal, an alloy, a plastic, a composite, and combinations thereof. A preferred construction material for the device of the invention is a titanium alloy of the type used for dental implants and known to be biologically benign. The device of the invention may be monolithic, or may comprise a plurality of pieces (of the same or different materials). The method of the invention for vertically positioning a dental implant having an implant upper portion, an implant margin, and an implant lower portion that includes an implant collar with a conical taper, comprises the steps of: (1) providing an implant positioning device comprising a device upper portion, and a device lower portion having a device collar and substantially the same external geometric shape and dimensions as those of the implant lower portion but without external screw threads or other mechanical features for anchoring the implant in the jawbone; (2) drilling a hole, of the diameter needed to fit the implant, at a predetermined location in the jawbone to a depth short of that expected to be required; (3) countersinking the hole to provide a countersunk area having a taper that matches the conical taper of the implant collar and ensures proper positioning of the final crown margin; (4) inserting the implant positioning device into the hole until the bottom end of the positioning device bottoms out at the bottom of the hole; (5) inspecting the location of the device margin with respect to the gum tissue, and the gap existing between the hole countersunk area and the device collar; (6) estimating the additional hole depth required based on the margin location and the geometry and width of the gap; (7) removing the implant positioning device from the hole; (8) drilling the hole deeper; and (9) repeating the steps of inserting the implant positioning device, inspecting the device margin location and the gap existing between the hole countersunk area and the device collar, estimating the additional hole depth required, removing the implant positioning device, and drilling the hole deeper, until the positioning device margin is properly located within the gum tissue and no substantial gap exists between the hole countersunk area and the device collar.

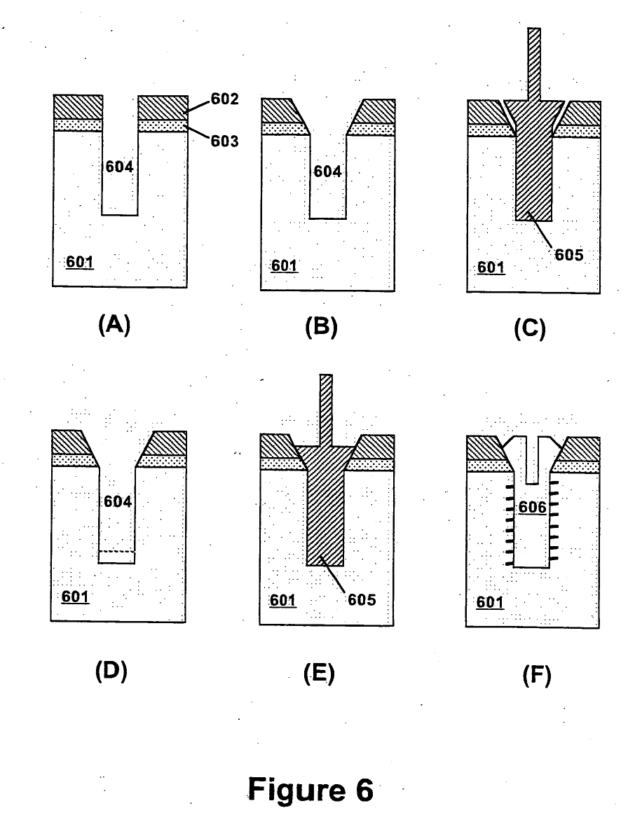

FIG. 6 illustrates the basic steps of a preferred embodiment of the method of the invention for vertical positioning of a dental implant when the gum tissue is relatively thick. As depicted in FIG. 6(A), a hole 604 of the diameter needed to fit the implant is drilled at a predetermined location in the jawbone (through the gum layer 602 and the cortical layer 603 and into the cancellous bone 601) to a depth slightly short of that expected to be required. As depicted in FIG. 6(B), hole 604 is countersunk to fit the conical taper on the implant 606, depicted in FIG. 6(F). As depicted in FIG. 6(C), an implant positioning device 605 comprising a lower portion, including a conically tapered collar, having substantially the same external geometric shape and dimensions as those of implant 606 but without external threads is inserted into hole 604 until the bottom end of positioning device 605 bottoms out at the bottom of hole 604. The position of the positioning device margin relative to the gum line, and the gap existing between the hole countersunk area and the conically tapered collar on the implant positioning device (FIG. 6C) are inspected and used estimate the additional hole depth required. A portion of gum layer 602 may be pulled back or surgically removed to facilitate inspection of the gap between cortical layer 603 and the tapered collar of positioning device 605. As depicted in FIG. 6(D), implant positioning device 605 is removed from hole 604, and hole 604 is drilled deeper (dashed line indicates original hole depth). The steps of inserting positioning device 605, inspecting the location of the margin and the width of the gap existing between the hole countersunk area and the tapered collar of positioning device 605, estimating the additional hole depth required, removing positioning device 605, and drilling the hole deeper are repeated until the implant margin is at the proper level (with respect to the gum tissue) for the final crown margin, and no substantial gap exists between the hole countersunk area and the conical taper area on positioning device 605, as depicted in FIG. 6(E).

Although not a step in the method of the invention, implant 606 may then be inserted in hole 601 at the preferred vertical position, as depicted in FIG. 6(F). Note that ideally the implant margin is about 2 mm below the gum line and the countersunk area extends through cortex 603, as depicted in FIG. 6(F), but the practically attainable vertical position of implant depends on the thickness of the gum and the cortex, both of which are normally uneven in thickness.

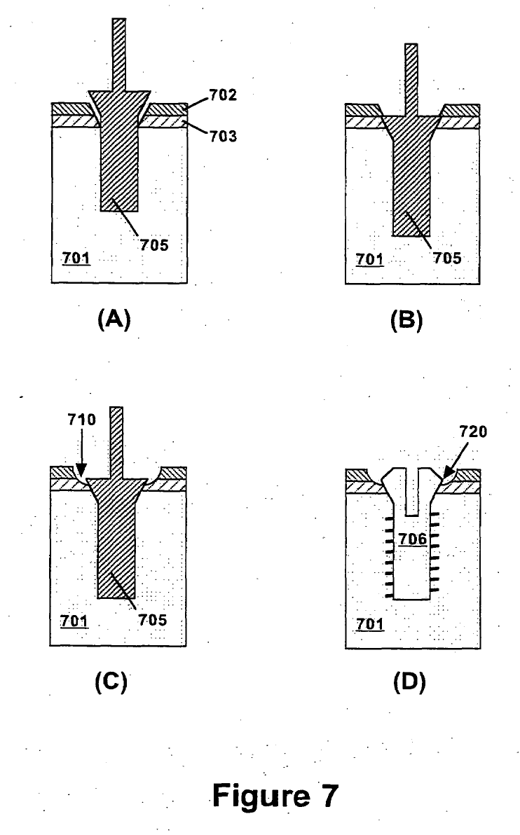

FIG. 7 illustrates use of the invention for vertical positioning of a dental implant when the gum tissue is relatively thin, and/or the implant must be placed deeper in the bone. In this case, use of the positioning device 705 (as described for FIG. 6) may result in the margin being flush with or below bone layer 703, as shown in FIG. 7(B), making the margin inaccessible for installation of an impression cap. As depicted in FIG. 7(C), bone and tissue may be removed in countersunk region 710 around the margin using the extended collar countersink bur of the invention, countersink bur 570 or 580 in FIGS. 5(H) and 5(I), for example. As depicted in FIG. 7(D), the margin 720 of the installed implant 706 is then accessible for installation of an impression cap, and a smooth crown emergence profile can be provided. The attainable emergence profile may be checked prior to installation of implant 606 using the extended collar positioning device of the invention, device 560 in FIG. 5(G), for example.

In the prior art practice, insufficient margin protrusion is only identified as an issue after the implant is installed. The only remedy in this case is to perform an additional surgical procedure (after the implant has settled) to remove cortical bone around the implant margin so that a snap-on impression cap, and ultimately a properly contoured crown, can be installed. The device of the invention, which has a margin equivalent to that of the implant, may be used (when fully inserted in the hole in the jawbone) to test whether the impression cap can be installed. If not, the countersunk area can be enlarged prior to insertion of the implant so that an additional surgery can be avoided.

The apparatus of the invention for vertically positioning a dental implant having an implant upper portion, an implant margin and an implant lower portion may further comprise an extended countersink bur used according to the method of the invention to produce a countersunk area whose profile includes sections that match the emergence profile of the implant collar and a desired emergence profile of the crown. Exemplary extended countersink burs 570 and 580 are depicted in FIGS. 5(H) and 5(I). Extended countersink burs 570 and 580 are preferably used with positioning device 560 having an extended collar, which is depicted in FIG. 5(G). The profiles of extended countersink burs 570 and 580 and the collar and extended collar sections of extended positioning device 560 are substantially the same. Use of the extended countersink bur and extended positioning device of the invention, in conjunction with a suitable healing cap, ensures that a suitable emergence profile for the crown can be attained.

An extended countersink bur according to the invention (570 and 580 in FIG. 5, for example) may be made of any suitable tool material, a stainless steel or a titanium alloy, for example. Mechanical coupling features may be added rotation shaft of the countersink bur to enable use of standard dental rotation equipment. The surface of the countersink bur cutting edge may include any suitable cutting features, including saw teeth or diagonal blades, for example, and may be coated with a hard material, a metal carbide or nitride, for example, to enhance cutting and/or reduce wear. A variety of modifications and alternative designs for the extended bur countersink bur of the invention will be apparent to those skilled in the art.

### DESCRIPTION OF A PREFERRED EMBODIMENT

In a preferred embodiment, the implant positioning device has a flat top surface (no shoulder) and is substantially identical to the portion of implant below the margin, minus the external threads. Preferably, the top of the implant and the top of the positioning device both include a threaded axial blind hole that mates to a screw on an implant insertion device, which is used as a handle to insert both the implant positioning device and the implant in the hole in the jawbone. A preferred method of the invention involves repeating the steps of inserting a preferred implant positioning device, inspecting the position of the margin (with respect to the gum line) and the width of the gap existing between the hole countersunk area and the conical taper area on the implant positioning device, estimating the additional hole depth required, removing the implant positioning device, and drilling the hole deeper until no substantial gap exists between the hole countersunk area and the conical taper area on the implant positioning device, except at the implant margin where the extended countersink bur has created space.

The preferred embodiments of the present invention have been illustrated and described above. Modifications and additional embodiments, however, will undoubtedly be apparent to those skilled in the art. Furthermore, equivalent elements may be substituted for those illustrated and described herein, parts or connections might be reversed or otherwise interchanged, and certain features of the invention may be utilized independently of other features. Consequently, the exemplary embodiments should be considered illustrative, rather than inclusive, while the appended claims are more indicative of the full scope of the invention.

I claim:

1. A method for vertically positioning a dental implant, said implant comprising an implant upper portion, an implant margin, and an implant lower portion that includes an implant collar with a conical taper, comprising the steps of:
providing an implant positioning device comprising a device upper portion, and a device lower portion having a device collar and substantially the same external geometric shape and dimensions as those of the implant lower portion but without external screw threads or other mechanical features for anchoring the implant in the jawbone;
drilling a hole, of the diameter needed to fit the implant, at a predetermined location in the jawbone to a depth short of that expected to be required;
countersinking the hole to provide a countersunk area having a taper that matches the conical taper of the implant collar;
inserting the implant positioning device into the hole until the bottom end of the positioning device bottoms out at the bottom of the hole;
inspecting the device margin location and the gap existing between the hole countersunk area and the device collar;
estimating the additional hole depth required;
removing the implant positioning device from the hole;
drilling the hole deeper; and
repeating the steps of inserting the implant positioning device, inspecting the device margin location and the gap existing between the hole countersunk area and the device collar, estimating the additional hole depth required, removing the implant positioning device, and drilling the hole deeper, until no substantial gap exists between the hole countersunk area and the device collar.

2. The method of claim 1, wherein at least some of the steps of the method are incorporated in a computer aided implant placement system to improve the precision and efficiency of the implant positioning.

3. The method of claim 1, further comprising the step of:
providing an extended countersink bur that produces a countersunk area whose profile includes sections that match the emergence profile of the implant collar and a desired emergence profile of the crown,
wherein the device upper portion comprises an extended device collar that is tapered to match a desired emergence profile of a crown to be attached to the implant.
